(19) United States
(12) Patent Application Publication
(10) Pub. No.: US 2026/0101230 A1
(43) Pub. Date: Apr. 9, 2026

(54) RADIO ACCESS NETWORK (RAN) ASSISTED QUALITY OF EXPERIENCE (QOE)-AWARE SOURCE BITRATE SELECTION

(71) Applicant: QUALCOMM Incorporated, San Diego, CA (US)

(72) Inventors: Belal Salama Amin KORANY, San Diego, CA (US); Peerapol TINNAKORNSRISUPHAP, San Diego, CA (US); Miguel GRIOT, La Jolla, CA (US); Prashanth Haridas HANDE, San Diego, CA (US); Hyun Yong LEE, San Diego, CA (US); Yih-Hao LIN, San Diego, CA (US)

(21) Appl. No.: 18/909,863

(22) Filed: Oct. 8, 2024

(51) Int. Cl. H04W 28/02

(52) U.S. Cl. CPC H04W 28/0268; H04W 28/0205

(57) ABSTRACT

Methods, systems, and devices for wireless communications are described. A wireless communications system may support immersive applications such as extended reality, mixed reality, interactive mapping, integration of artificial intelligence, among other services which may utilize high quality and low latency video streams. To support improved integration between network components providing applications, and to increase quality of experience (QoE) for users, the wireless communications system may implement radio access network (RAN)-assisted QoE-aware source bitrate selection. In some aspects, an application server may provide a RAN node with bitrate information for one or more users, including at least a first bitrate that maintains a threshold QoE for a threshold duration. The RAN node may determine, based on various factors such as network load, load balancing, obtainable QoE across users, among other factors, a selected bitrate for the one or more users and may provide the selected bitrate to the application server.

### FIELD OF TECHNOLOGY

The following relates to wireless communications, including radio access network (RAN) assisted quality of experience (QoE)-aware source bitrate selection.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a radio access network (RAN) node is described. The method may include obtaining one or more first messages indicative of at least a first bitrate that maintains a threshold quality of experience (QoE) for operations at a user equipment (UE) spanning at least a threshold duration of time and outputting, in accordance with the one or more first messages, one or more second messages indicative of a selected bitrate for the UE.

A RAN node for wireless communications is described. The RAN node may include one or more memories storing processor executable code, and one or more processors coupled with the one or more memories. The one or more processors may individually or collectively be operable to execute the code to cause the RAN node to obtain one or more first messages indicative of at least a first bitrate that maintains a threshold QoE for operations at a UE spanning at least a threshold duration of time and output, in accordance with the one or more first messages, one or more second messages indicative of a selected bitrate for the UE.

Another RAN node for wireless communications is described. The RAN node may include means for obtaining one or more first messages indicative of at least a first bitrate that maintains a threshold QoE for operations at a UE spanning at least a threshold duration of time and means for outputting, in accordance with the one or more first messages, one or more second messages indicative of a selected bitrate for the UE.

A non-transitory computer-readable medium storing code for wireless communications is described. The code may include instructions executable by one or more processors to obtain one or more first messages indicative of at least a first bitrate that maintains a threshold QoE for operations at a UE spanning at least a threshold duration of time and output, in accordance with the one or more first messages, one or more second messages indicative of a selected bitrate for the UE.

In some examples of the method, RAN nodes, and non-transitory computer-readable medium described herein, wherein at least the first bitrate comprises a set of bitrate values and the threshold QoE comprises a set of threshold QoE values and the method, apparatuses, and non-transitory computer-readable medium may include further operations, features, means, or instructions for mapping, in accordance with a user experience function, the set of bitrate values to corresponding threshold QoE values of the set of threshold QoE values during the threshold duration of time.

In some examples of the method, RAN nodes, and non-transitory computer-readable medium described herein, wherein at least the first bitrate comprises a set of bitrate values and the threshold QoE comprises a set of threshold QoE values and the method, apparatuses, and non-transitory computer-readable medium may include further operations, features, means, or instructions for obtaining a first bitrate value of the set of bitrate values required to maintain a first threshold QoE value of the set of threshold QoE values at a first time and obtaining a second bitrate value of the set of bitrate values required to maintain a second threshold QoE value of the set of threshold QoE values at a second time different from the first time.

In some examples of the method, RAN nodes, and non-transitory computer-readable medium described herein, the first bitrate value may be different from the second bitrate value as a result of one or more application content changes at the UE, and the first threshold QoE value may be different from the second threshold QoE value as a result of the one or more application content changes at the UE.

In some examples of the method, RAN nodes, and non-transitory computer-readable medium described herein, the one or more application content changes include one or more changes in video content complexity, extended reality content complexity, virtual reality content complexity, mixed reality content complexity, one or more changes in streaming content, or any combination thereof.

In some examples of the method, RAN nodes, and non-transitory computer-readable medium described herein, the one or more first messages further include packet data unit (PDU) set metadata indicative of data traffic at the UE.

In some examples of the method, RAN nodes, and non-transitory computer-readable medium described herein, obtaining the one or more first messages may include operations, features, means, or instructions for obtaining the one or more first messages from an application server via a session management function.

Some examples of the method, RAN nodes, and non-transitory computer-readable medium described herein may further include operations, features, means, or instructions for outputting an indication of a request to update the threshold QoE based on satisfaction of one or more criteria.

In some examples of the method, RAN nodes, and non-transitory computer-readable medium described herein, satisfaction of the one or more criteria includes completion of a threshold periodicity, an occurrence of one or more events corresponding to a change in QoE, or both.

In some examples of the method, RAN nodes, and non-transitory computer-readable medium described herein, obtaining the one or more first messages may include operations, features, means, or instructions for obtaining the one or more first messages via one or more application servers associated with one or more respective UEs, the method further including, calculating, in accordance with respective link conditions associated with the one or more respective UEs, a resource distribution for the one or more respective UEs, where the resource distribution includes a selected bitrate that satisfies a QoE-based network utility function for a threshold quantity of the one or more respective UEs, and outputting, to the one or more application servers, one or more QoS notification messages indicative of the selected bitrate.

Some examples of the method, RAN nodes, and non-transitory computer-readable medium described herein may further include operations, features, means, or instructions for calculating an updated resource distribution for the one or more respective UEs, the updated resource distribution including updated selected bitrates associated with the one or more respective UEs and outputting one or more updated QoS notification messages based on the updated selected bitrates.

In some examples of the method, RAN nodes, and non-transitory computer-readable medium described herein, the one or more QoS notification messages includes an indication of whether the threshold QoE will be achieved by at least one of the one or more respective UEs.

In some examples of the method, RAN nodes, and non-transitory computer-readable medium described herein, calculating the resource distribution and the selected bitrate for the one or more respective UEs may include operations, features, means, or instructions for calculating the resource distribution and the selected bitrate in accordance with a bitrate selection algorithm implemented at the RAN node.

Some examples of the method, RAN nodes, and non-transitory computer-readable medium described herein may further include operations, features, means, or instructions for outputting, to the UE, an indication of a requested set of UE measurements to perform and obtaining, from the UE, a measurement reporting including the requested set of UE measurements in accordance with the indication.

In some examples of the method, RAN nodes, and non-transitory computer-readable medium described herein, the selected bitrate satisfies the first bitrate that maintains the threshold QoE, or the selected bitrate fails to satisfy the first bitrate that maintains threshold QoE based on a capacity of the RAN node.

In some examples of the method, RAN nodes, and non-transitory computer-readable medium described herein, the threshold duration of time includes a threshold quantity of frames or a threshold quantity of time segments.

A method for wireless communications by an application function is described. The method may include outputting one or more first messages indicative of at least a first bitrate that maintains a threshold QoE for operations at a UE spanning at least a threshold duration of time and obtaining, in accordance with the one or more first messages, one or more second messages indicative of a selected bitrate for the UE.

An application function for wireless communications is described. The application function may include one or more memories storing processor executable code, and one or more processors coupled with the one or more memories. The one or more processors may individually or collectively be operable to execute the code to cause the application function to output one or more first messages indicative of at least a first bitrate that maintains a threshold QoE for operations at a UE spanning at least a threshold duration of time and obtain, in accordance with the one or more first messages, one or more second messages indicative of a selected bitrate for the UE.

Another application function for wireless communications is described. The application function may include means for outputting one or more first messages indicative of at least a first bitrate that maintains a threshold QoE for operations at a UE spanning at least a threshold duration of time and means for obtaining, in accordance with the one or more first messages, one or more second messages indicative of a selected bitrate for the UE.

A non-transitory computer-readable medium storing code for wireless communications is described. The code may include instructions executable by one or more processors to output one or more first messages indicative of at least a first bitrate that maintains a threshold QoE for operations at a UE spanning at least a threshold duration of time and obtain, in accordance with the one or more first messages, one or more second messages indicative of a selected bitrate for the UE.

In some examples of the method, application functions, and non-transitory computer-readable medium described herein, wherein at least the first bitrate comprises a set of bitrate values and the threshold QoE comprises a set of threshold QoE values and the method, apparatuses, and non-transitory computer-readable medium may include further operations, features, means, or instructions for estimating, in accordance with a user experience function, the set of bitrate values to corresponding threshold QoE values of the set of threshold QoE values during the threshold duration of time.

In some examples of the method, application functions, and non-transitory computer-readable medium described herein, wherein at least the first bitrate comprises a set of bitrate values and the threshold QoE comprises a set of threshold QoE values and the method, apparatuses, and non-transitory computer-readable medium may include further operations, features, means, or instructions for obtaining a first bitrate value of the set of bitrate values required to maintain a first threshold QoE value of the set of threshold QoE values at a first time and obtaining a second bitrate value of the set of bitrate values required to maintain a second threshold QoE value of the set of threshold QoE values at a second time different from the first time.

In some examples of the method, application functions, and non-transitory computer-readable medium described herein, the first bitrate value may be different from the second bitrate value as a result of one or more application content changes associated with operations at the UE, and the first threshold QoE value may be different from the second threshold QoE value as a result of one or more application content changes at the UE.

In some examples of the method, application functions, and non-transitory computer-readable medium described herein, the one or more application content changes include one or more changes in video content complexity, extended reality content complexity, virtual reality content complexity, mixed reality content complexity, one or more changes in streaming content, or any combination thereof.

In some examples of the method, application functions, and non-transitory computer-readable medium described herein, the one or more first messages further include PDU set metadata indicative of data traffic at the UE.

Some examples of the method, application functions, and non-transitory computer-readable medium described herein may further include operations, features, means, or instructions for obtaining, from a RAN node, an indication of a request to update the threshold QoE based on satisfaction of one or more criteria.

In some examples of the method, application functions, and non-transitory computer-readable medium described herein, the satisfaction of the one or more criteria include completion of a threshold periodicity, an occurrence of one or more events corresponding to a change in QoE, or both.

Some examples of the method, application functions, and non-transitory computer-readable medium described herein may further include operations, features, means, or instructions for obtaining one or more QoS notification messages indicative of a bitrate required to maintain the threshold QoE for operations at the UE and one or more other UEs.

Some examples of the method, application functions, and non-transitory computer-readable medium described herein may further include operations, features, means, or instructions for obtaining one or more updated QoS notification messages including updated selected bitrates based on one or more changes to resource distribution for the UE and the one or more other UEs.

Some examples of the method, application functions, and non-transitory computer-readable medium described herein may further include operations, features, means, or instructions for modifying an encoding bitrate at the application function in accordance with the selected bitrate.

In some examples of the method, application functions, and non-transitory computer-readable medium described herein, the one or more QoS notification messages includes an indication of whether the threshold QoE will be achieved by the UE.

In some examples of the method, application functions, and non-transitory computer-readable medium described herein, the threshold duration of time includes a threshold quantity of frames or a threshold quantity of time segments.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio access network (RAN) assisted quality of experience (QoE)-aware source bitrate selection in accordance with one or more aspects of the present disclosure.

FIG. 2 shows an example of a network architecture that supports RAN assisted QoE-aware source bitrate selection in accordance with one or more aspects of the present disclosure.

FIG. 3 shows an example of a wireless communications system that supports RAN assisted QoE-aware source bitrate selection in accordance with one or more aspects of the present disclosure.

FIG. 4 shows an example of a process flow that supports RAN assisted QoE-aware source bitrate selection in accordance with one or more aspects of the present disclosure.

FIGS. 5 and 6 show block diagrams of devices that support RAN assisted QoE-aware source bitrate selection in accordance with one or more aspects of the present disclosure.

FIG. 7 shows a block diagram of a communications manager that supports RAN assisted QoE-aware source bitrate selection in accordance with one or more aspects of the present disclosure.

FIG. 8 shows a diagram of a system including a device that supports RAN assisted QoE-aware source bitrate selection in accordance with one or more aspects of the present disclosure.

FIGS. 9 through 12 show flowcharts illustrating methods that support RAN assisted QoE-aware source bitrate selection in accordance with one or more aspects of the present disclosure.

### DETAILED DESCRIPTION

A wireless communications system may support advanced technologies to enable implementation of a cyber-physical network. For example, the wireless communications system may support immersive applications such as immersive virtual realities, extended reality, mixed reality, interactive mapping, integration of artificial intelligence, among other applications. In some aspects, immersive applications may utilize high reliability latency-bound (e.g., real-time) video streams which require little to no buffering and relatively high data rates. For such applications and other advanced technologies, maintaining acceptable levels of user experience and quality of experience (QoE), for example, maintaining user experience and QoE at or above a quality threshold, is important.

In some implementations, the wireless communications system may utilize measurements of data rate, latency, among other quality-based measurement frameworks in order to evaluate QoE for various applications run at a user equipment (UE). In some cases, however, measurements of data rate and latency (among other metrics) may be inadequate to fully evaluate QoE for UEs running different applications. That is, evaluations of some quality of service (QoS)-based metrics may be inadequate to maintain acceptable QoE due to frequent channel variation and network loading conditions. Additionally, or alternatively, an application server generating video or streaming traffic may be configured separate from the radio access network (RAN), which may cause challenges for effectively maintaining high quality content for multiple UEs in a system.

To support enhanced QoE and increased overall user experience for immersive applications and other advanced technologies for users, the wireless communications system may support RAN-assisted QoE-aware source bitrate selection to provide high quality services for multiple UEs. For example, the wireless communications system may support granular coordination between a RAN node, an application server, and UEs, to more effectively allocate resources and support improved QoE for multi-user systems.

In some examples, the application server may estimate the QoE as a function of bitrate over time (e.g., for the next N frames or time segments), and may output information related to the estimated QoE to the RAN node. In some examples, the QoE information provided by the application server may be bitrate information, and may include one or more points on the function mapping bitrate to QoE. Additionally, or alternatively, the QoE information provided by the application server may include a first bitrate (e.g., a minimum bitrate) that maintains the threshold QoE for the UE. The RAN node may utilize the QoE information to determine one or more bitrates for UEs in the system. For example, the RAN node may implement one or more bitrate selection algorithms to determine respective bitrates for UEs, where the bitrate selection algorithms may maximize the total number of UEs that are successfully able to obtain and maintain a threshold QoE. The RAN node may then communicate the bitrate values to the application server, which may provide application services for the UEs.

Aspects of the disclosure may be implemented to realize one or more potential advantages. For example, RAN-assisted QoE-aware source bitrate selection techniques may provide higher quality video streaming and other low latency services for multiple users in a system by more effectively allocating system bitrates across different UEs. For example, the RAN node may be able to determine more evenly distribute bitrates for users so that relatively more users maintain a threshold QoE. Additionally, or alternatively, the techniques described herein may allow for more adaptable bitrate delivery based on content changes. For example, changes in streaming content or content complexity may be more effectively identified and bitrates may be modified based on content changes. Additionally, or alternatively, the techniques described herein may allow for increased RAN-level awareness of QoE for multiple users, which may allow for more balanced resource allocation throughout a wireless system.

Aspects of the disclosure are initially described in the context of wireless communications systems. Aspects of the disclosure are further illustrated by and described with reference to a process flow apparatus diagrams, system diagrams, and flowcharts that relate to RAN assisted QoE-aware source bitrate selection.

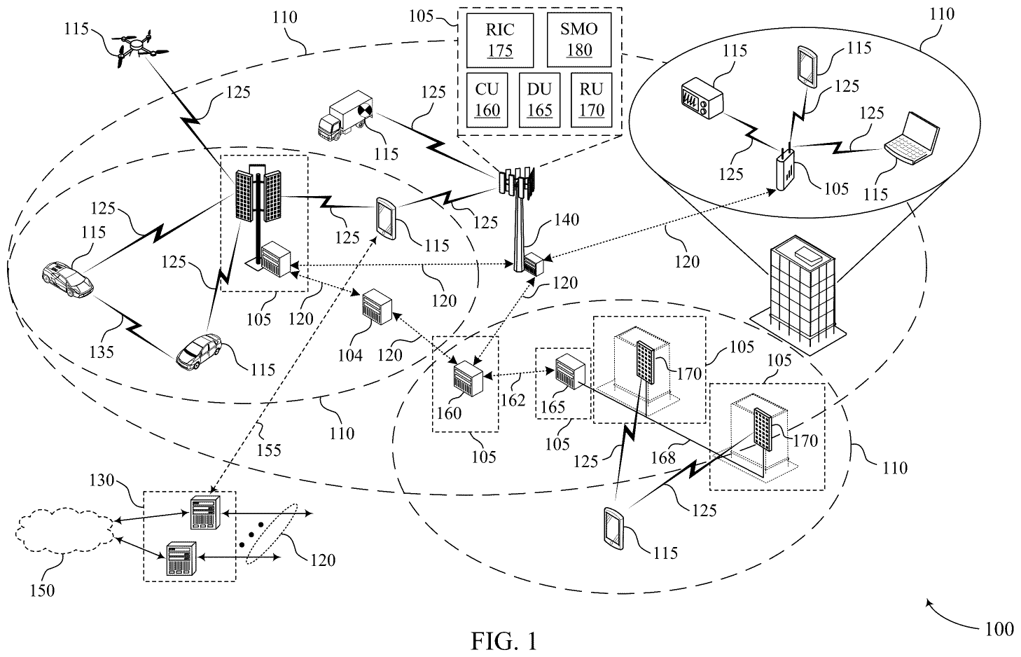

FIG. 1 shows an example of a wireless communications system 100 that supports RAN assisted QoE-aware source bitrate selection in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support RAN assisted QoE-aware source bitrate selection as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support advanced technologies including immersive applications (e.g., virtual realities, extended reality, mixed reality, interactive mapping, integration of artificial intelligence, among other applications). In some aspects, immersive applications may utilize high reliability latency-bound video streams which require little to no buffering and relatively high data rates, and high QoE. In some implementations, the wireless communications system 100 may utilize measurements of data rate, latency, among other quality-based measurement frameworks in order to evaluate QoE for various applications run at a UE 115. In some cases, however, measurements of data rate and latency (among other metrics) may be inadequate to fully evaluate QoE for UEs running different applications. That is, evaluations of some QoS-based metrics may be inadequate to maintain acceptable QoE due to frequent channel variation and network loading conditions. Additionally, or alternatively, an application server generating video or streaming traffic may be configured separate from the RAN, which may cause challenges for effectively maintaining high quality content for multiple UEs in a system.

To support enhanced QoE and increased overall user experience for immersive applications and other advanced technologies for users, the wireless communications system 100 may support RAN-assisted QoE-aware source bitrate selection to provide high quality services for multiple UEs. For example, the wireless communications system may support granular coordination between a RAN node, an application server, and UEs 115, to more effectively allocate resources and support improved QoE for multi-user systems. In some examples, the application server may estimate the QoE as a function of bitrate over time, and may output information related to the estimated QoE to the RAN node. In some examples, the QoE information provided by the application server may be bitrate information, and may include one or more points on the function mapping bitrate to QoE. Additionally, or alternatively, the QoE information provided by the application server may include a first bitrate (e.g., a minimum bitrate) that maintains the threshold QoE for the UE 115. The RAN node may utilize the QoE information to determine one or more bitrates for UEs in the system such that the total number of UEs 115 that are successfully able to obtain and maintain a threshold QoE is maximized.

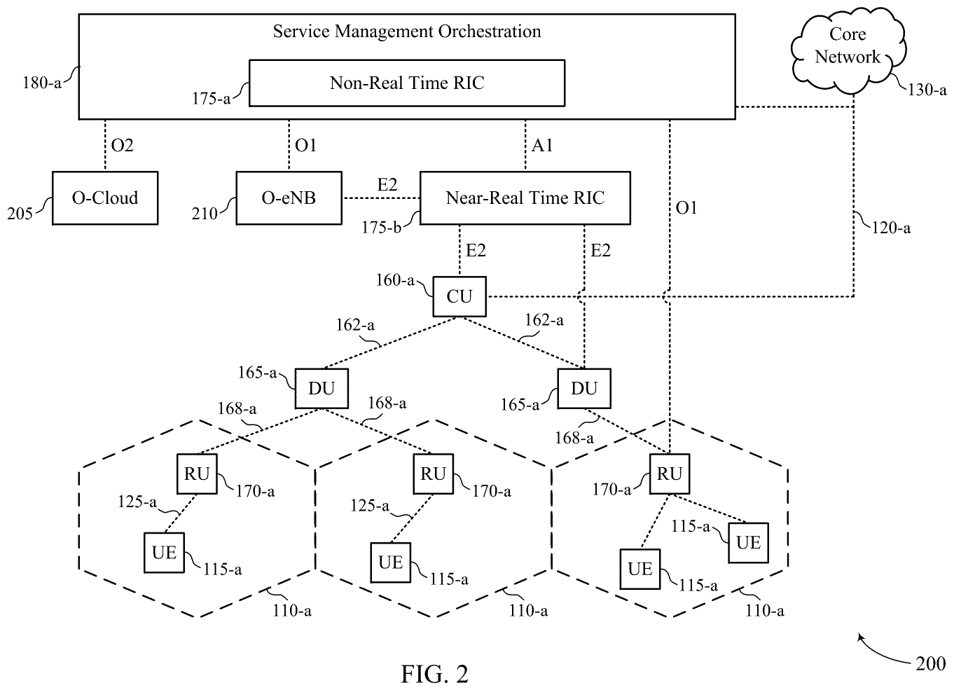

FIG. 2 shows an example of a network architecture 200 (e.g., a disaggregated base station architecture, a disaggregated RAN architecture) that supports RAN assisted QoE-aware source bitrate selection in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

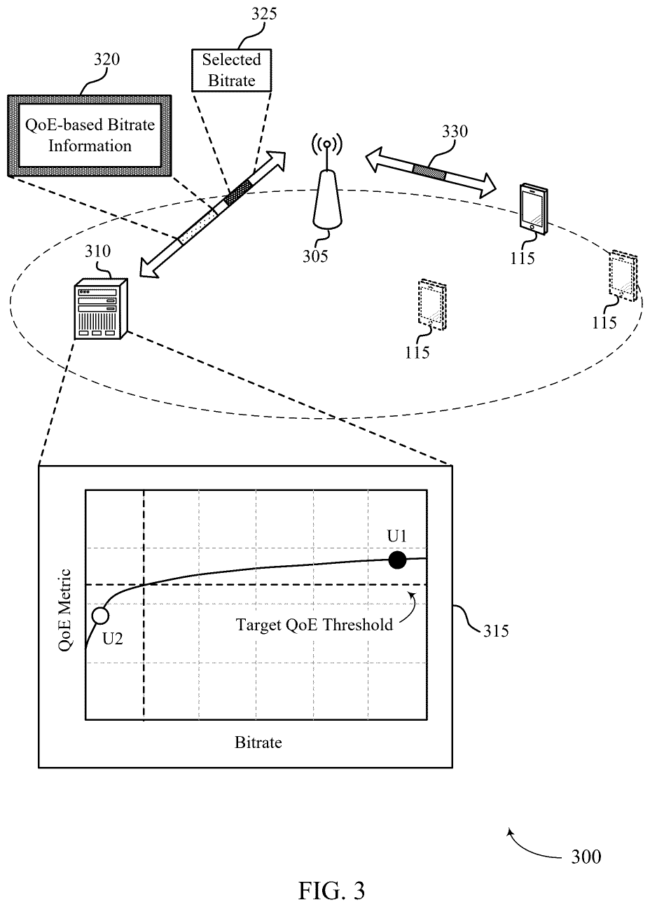

FIG. 3 shows an example of a wireless communications system 300 that supports RAN assisted QoE-aware source bitrate selection in accordance with one or more aspects of the present disclosure. For example, the wireless communications system 300 illustrates communication between network devices (such as a RAN node 305 and an application server 310, each of which may be examples of network entities 105 described with reference to FIG. 1, or other network nodes described with reference to FIG. 1) and a UEs 115, each of which may be examples of UEs 115 described with reference to FIG. 1.

The wireless communications system 300 may support advanced technologies to enable implementation of a cyber-physical network or integrated cyber-physical world, which merges both physical and digital realities. For example, the wireless communications system 300 may support immersive applications such as immersive holographic telepresence with extended reality, mixed reality, interactive mapping, digital twin and virtual worlds, situational awareness, integration of artificial intelligence and artificial intelligence as a service (AIaaS), among other services. In some aspects, immersive applications may utilize high reliability latency-bound (e.g., real-time) video streams with little to no buffering, and high data rates. For such applications and other advanced technologies, maintaining acceptable levels of user experience and quality of experience (QoE), for example, maintaining user experience and QoE at or above a quality threshold, is essential.

In some implementations, the wireless communications system 300 may utilize measurements of data rate, latency, among other quality-based measurement frameworks in order to evaluate QoE for various applications. In some cases, however, measurements of data rate and latency (among other metrics) may be inadequate to fully evaluate QoE for UEs running different applications. That is, evaluations of some QoE-based metrics may be inadequate to maintain acceptable QoE due to frequent channel variation and network loading conditions. Additionally, or alternatively, some systems may implement frameworks in which compute and multimedia systems are designed separately with specific assumptions on communications channels, which may limit integration between computation and media delivery. For example, an application server generating video or streaming traffic may be configured separate from the communications of a wireless network (and may have limited knowledge of the operation of the wireless network), and conversely, the wireless network may be configured separately from the application server generating the video traffic, and thus may have limited knowledge regarding the content of the traffic.

In some cases, the wireless communications system 300 may support communications for multiple UEs 115 that experience different channel conditions. In some such cases, QoE may be evaluated based on a user experience plot 315 of an application quality metric (e.g., PSNR, SNR, or another quality metric) versus bitrate supplied for each UE 115, supplied by the application server 310. In some aspects, the user experience for each UE 115 may flatten or saturate as supplied bitrate increases, that is, user experience may increase greatly (e.g., by several units of PSNR) for an initially supplied bitrate, but may level off and increase more gradually or flatten as higher bitrates are supplied. In such cases, poor resource distribution among users (based on source unawareness of link conditions and link loading along with QoE unawareness at the RAN node 305) may result in substantial gaps in bitrate assignments to users experiencing asymmetric channel conditions. For example, a first user (e.g., U1, which may be an example of a first UE 115) may be assigned excess bitrate (e.g., bitrate that is more than sufficient to obtain a threshold QoE), while a second user (e.g., U2, which may be an example of a second UE 115) may lack sufficient bitrate to obtain the threshold QoE. Poor resource allocation among users may therefore cause inefficiencies in resource distribution while also reducing the QoE for some users within the system. For example, the additional bitrate allocated for the first user may be re-allocated to the second user, which may result in a significant increase in user experience for the second user, while still maintaining a similar user experience for the first user.

To support enhanced QoE and increased overall user experience for immersive applications and other advanced technologies for users, the wireless communications system 300 may support efficient resource allocation to increase the QoE for users with poor channel conditions, while maintaining the QoE for other users with good channel conditions. For example, the wireless communications system 300 may support granular coordination between the RAN node 305, the application server 310, the UEs 115, and other network components, to more effectively allocate resources and support improved QoE for multi-user systems.

In some aspects, the wireless communications system 300 may support increased application awareness at the RAN node 305 to enable RAN-assisted QoE-based source bitrate selection. For example, increased application awareness may include packet data unit (PDU) set awareness, including RAN-level awareness of one or more PDUs carrying a payload of one unit of information generated at an application level (e.g., video frame(s), video slice(s), etc. for extended reality services). Additionally, or alternatively, increased RAN-level awareness of application level functionality may include time-sensitive communication assistance information (TSCAI) enhancements to shift burst traffic timing adjustment, data rate adaptation, and framerate.

In some implementations, to increase the QoE capacity of the wireless communications system (e.g., the total quantity of UEs that meet the threshold QoE) and improve individual QoE for UEs in the wireless communications system 300, the application server 310 may provide QoE information 320 (e.g., video complexity information, streaming information, video content in real time) in the form of the user experience plot 315 to the RAN node 305, so that the RAN node 305 may effectively allocate resources (e.g., bitrate) to UEs 115, and to maximize the total quantity of UEs that satisfy a threshold QoE. For example, if the threshold or target QoE is associated with a first metric (such as 36 dB PSNR), the application server 310 may identify a corresponding bitrate (e.g., 10 Mbps bitrate) that is required to maintain the threshold QoE, and may provide the bitrate information to the RAN node 305 via the QoE information 320. In some cases, the application server 310 may provide updated bitrate information based on various factors such as dynamic changes in the complexity of video content or other streaming changes for the application.

In some examples, the application server 310 may estimate the QoE as a function of bitrate (e.g., the user experience plot 315) for a quantity time (e.g., for the next N frames or time segments, where N is one or more), and may output information related to the estimated QoE to the RAN node 305. In some examples, the QoE information 320 provided by the application server 310 may be bitrate information, and may include one or more points on the function mapping bitrate to QoE (e.g., one or more points on the user experience plot 315). Additionally, or alternatively, the QoE information 320 provided by the application server 310 may include a first bitrate (e.g., a minimum bitrate) that maintains the threshold QoE for the UE 115. In some examples, the RAN node 305 may receive the QoE information 320 from multiple servers (e.g., one or more servers which may either include or exclude the application server 310).

In some implementations, the application server 310 may include the QoE information 320 in one or more messages that include PDU set metadata. For example, each PDU set may include metadata that includes information related to the PDU set (e.g., related to PDUs belonging to the PDU set). The PDU set metadata may indicate a number (e.g., quantity) of PDUs in a PDU set, a PDU set sequence number that identifies the PDU set, a PDU sequence number that identifies a PDU within the PDU set, a PDU set burst number, a PDU set discard time, or the like, among other examples. In some cases, PDU set metadata may include fields that define rules for determining the delivery status of a PDU set. For example, the PDU set metadata may define the number, ratio, or percentage of PDUs in a PDU set to be received for successful PDU set delivery. In some examples, the application server 310 may include the QoE information 320 in the PDU set metadata (e.g., the QoE information 320 may be multiplexed or piggybacked with the PDU set metadata, or may be included in one or more fields of the PDU set metadata). In some such examples, a service layer in a UPF may receive the PDU set metadata from the application server 310, and may signal or forward the PDCU set metadata (including the QoE information 320) to the RAN node 305, the UE 115, or both. In some other implementations, the application server 310 may forward the QoE information 320 to a session management function (e.g., through a network exposure function (NEF)), which forwards the QoE information 320 to the RAN node 305.

In some implementations, the RAN node 305 may transmit, to the application server 310, one or more criteria for updating the QoE information 320. For example, the RAN node 305 may request that the QoE information 320 is updated based on a periodicity (e.g., updates to the QoE information 320 are sent by the application server 310 after each N frames, or after passage of a threshold duration of time such as N milliseconds). Additionally, or alternatively, the RAN node 305 may request that the QoE information 320 is updated after one or more events occur. For example, the RAN node 305 may identify a PSNR to bitrate change percentage (e.g., a QoE change) that exceeds a threshold change percentage, a change to video complexity, or a video scene change, or any combination thereof, and may transmit a request to the application server 310 to provide updated QoE information.

After receiving the QoE information 320, the RAN node 305 may calculate an “optimal” resource distribution (e.g., bitrate distribution) for the UEs 115 based on both the QoE information 320 and the current link conditions experienced by the UEs 115. In some aspects, the “optimal” resource distribution may be a resource distribution among UEs 115 which allows for the total quantity of UEs that meet or exceed the threshold QoE to be maximized. In some examples, the RAN node 305 may implement one or more optimization algorithms to determine the “optimal” resource distribution including supported bitrate values 325 for the UEs 115. In such examples, the one or more optimization algorithms may include inputs which may include, but are not limited to, a minimum required bitrate to support respective threshold QoEs for respective UEs, and outputs which may include supported bitrate values 325 for each of the respective UEs.

In some implementations, the RAN node 305 may transmit one or more messages that indicate the application server 310 of the supported bitrate values 325 calculated for the UEs 115 at the RAN node 305. In some examples, the one or more messages may include augmented QoS notification messages. In some aspects, the RAN node may transmit QoS notification messages, which may include information regarding guaranteed flow bitrate (GFBR) to the application server 310 via other network nodes (e.g., the RAN may transmit the QoS notification messages to a core access and mobility management function (AMF), which forwards the QoS notification messages to a session management function (SMF), which forwards the QoS notification messages to a policy control function (PCF)). The RAN node 305 may append, augment, add, or include the supported bitrate values 325 with the QoS notification messages. In some examples, an appended QoS notification message may include an indication (e.g., a notification, a flag) which indicates whether the threshold QoE may be achieved (e.g., based on the optimization algorithm) for one or more UEs 115. The application server 310 may then, responsive to the QoS notification message indicating that the threshold QoE may not be achieved, indicate instructions to switch to a local rendering.

In some aspects, the application server 310 may adapt an encoding bitrate to match the selected bitrate value indicated by the RAN node 305. For example, the selected bitrate value may be a trigger condition that triggers the application server 310 to modify or adapt a current encoding bitrate to a different selected bitrate for a UE 115. In some aspects, the RAN node 305 may receive measurement reporting 330 from the UE 115 which may indicate a set of QoE-based measurements that the RAN node 305 may utilize (at least in part) to identify the supported bitrate values 325.

The implementation of RAN-assisted source bitrate selection may allow for increased network coordination and more efficient selection of bitrates for multi-user systems. Additionally, or alternatively, the RAN-assisted source bitrate selection may allow for relatively more users to meet or exceed their respective QoE targets. In addition, the RAN-assisted source bitrate selection techniques described herein may allow for an increased amount of information available to the RAN node 305, which may allow for improved adaptation to video content, dynamic changes occurring for the video content, and dynamic resource allocation based on different content delivered to different users.

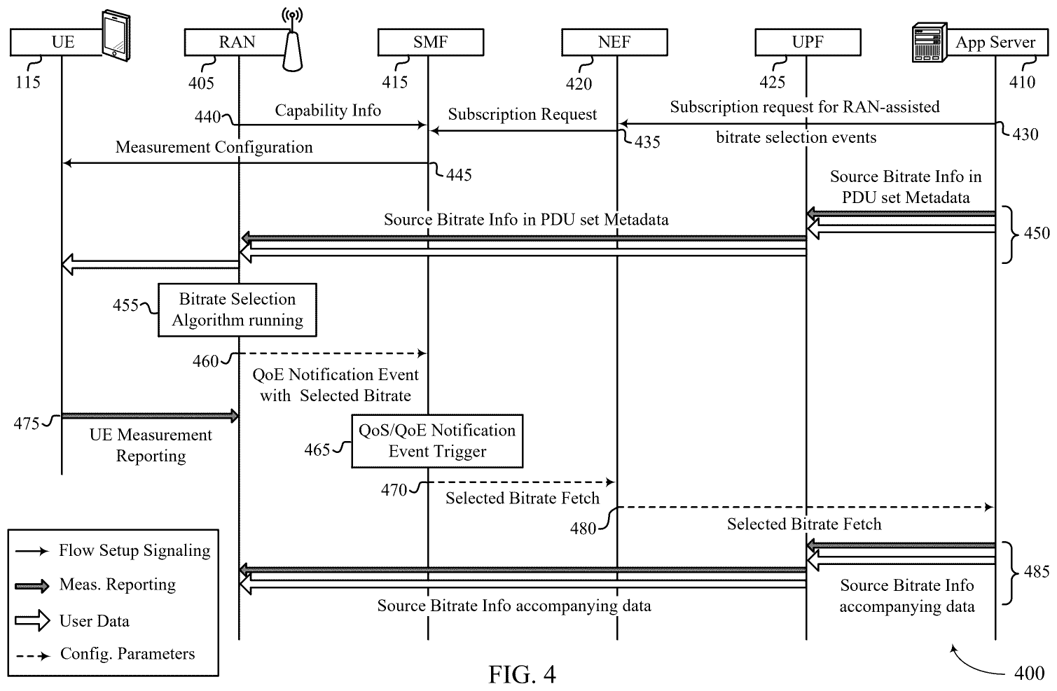

FIG. 4 shows an example of a process flow 400 that supports RAN assisted QoE-aware source bitrate selection in accordance with one or more aspects of the present disclosure. For example, the process flow 400 may illustrate a communications flow or call flow between a UE 115 (which may be an example of UE 115 described with reference to FIGS. 1 and 3), a RAN node 405, (which may be an example of a RAN node or network entity 105 described herein), an application server 410 (which may be an example of an application server described herein), an SMF 415, an NEF 420, and a UPF 425.

Alternative examples of the following may be implemented. Some steps are performed in a different order than described herein or are not performed at all. In some implementations, steps may include additional features not mentioned below, or additional steps may be added. Further, although a UE 115, a RAN node 405, an application server 410, an SMF 415, an NEF 420, and a UPF 425 are illustrated performing the operations of the process flow 400, some aspects of some operations may also be performed by one or more other network functions, network entities, or wireless communications devices.

At 430, the application server 410 may output, to the NEF 420 via flow setup signaling, a subscription request for RAN-assisted bitrate selection events.

At 435, the NEF 420 may forward the subscription request for RAN-assisted bitrate selection events to the SMF 415 via flow setup signaling.

In some examples, at 440, the RAN node 405 may output, to the SMF 415 via flow setup signaling, capability information which indicates a capability of the RAN node 405 to support RAN-assisted bitrate selection events.

At 445, the SMF 415 may (optionally) output, to the UE 115 via flow setup signaling, a measurement configuration including a set of measurements (e.g., QoS measurements) or other information for the UE 115 to report.

At 450, the application server 410 may output, to the UPF 425 via measurement reporting signaling, user data signaling, or both, source bitrate information (e.g., one or more points on a user experience function mapping bitrate to QoE or a first bitrate/minimum bitrate that maintains the threshold QoE for the UE 115) via one or more messages. In some examples, the one or more messages may include PDU set metadata. In some examples, the one or more messages may be appended with or multiplexed with the PDU set metadata. The UPF 425 may forward the source bitrate information to the RAN node 405, and the RAN node 405 may forward the source bitrate information (including a selected bitrate) to the UE 115.

In some examples, the RAN node 405 may map the source bitrate information (which may include one or more bitrate values) to the user experience function to select a bitrate over a duration of time (e.g., a next N frames, a configured duration associated with video content supported by the UE 115). In some examples, the source bitrate information may include a first bitrate value which is required to maintain a first threshold QoE value for the UE 115 at a first time, and a second bitrate value which is required to maintain a second threshold QoE value at a second time. For example, the first bitrate value may maintain the first threshold QoE value while the UE 115 supports a first application content (e.g., a first video complexity) and the second bitrate value may maintain the second threshold QoE value while the UE 115 supports a second application content (e.g., a second video complexity different from the first video complexity). In some cases, the RAN node 405 may identify different bitrate values based on ongoing changes in the video content supported by the UE 115 (e.g., one or more changes in video content complexity, extended reality content complexity, virtual reality content complexity, mixed reality content complexity, one or more changes in streaming content, or any combination thereof).

In some implementations, at 455, the RAN node 405 may run one or more bitrate selection algorithms to determine (e.g., select, calculate) a selected bitrate for the UE 115. In some cases, the RAN node 405 may run the one or more bitrate selection algorithms prior to, concurrently with, or after transmission of the source bitrate information via the PDU set metadata. In some aspects, the RAN node 405 may calculate (using respective link conditions associated with the UE 115 and any other UEs present in the system) a resource distribution for the UE 115. In some examples, the resource distribution may include the selected bitrate, which satisfies a QoE-based network utility function for a threshold quantity of the one or more respective UEs.

At 460, the RAN node 405 may output, to the SMF 415 via configuration parameter signaling, an indication of a QoS/QoE notification event which includes the selected bitrate for the UE 115. In some aspects, the indication of the QoS/QoE notification event may include a request to update the threshold QoE based on satisfaction of one or more criteria (e.g., completion of a threshold periodicity, an occurrence of one or more events corresponding to a change in QoE, or both). In some examples, the QoS/QoE notification event may be included in one or more QoS notification messages, and may (optionally) include an indication of whether the UE 115 is able to achieve the threshold QoE. For example, in some cases, the selected bitrate by the RAN node 405 may satisfy the first bitrate (e.g., the minimum bitrate) that maintains the threshold QoE, and in some other cases, the selected bitrate by the RAN node 405 may fail to satisfy the first bitrate that maintains the threshold QoE.

At 465, the SMF 415 may obtain the QoS/QoE notification event, which may trigger the SMF 415 to output, to the NEF 420 via configuration parameter signaling at 470, an indication to fetch the selected bitrate.

In some examples, at 475, the UE 115 may transmit measurement reporting to the RAN node 405, which may include one or more QoS/QoE measurements based on the received measurement configuration. In some examples, the RAN node 405 may use the one or more QoS/QoE measurements to determine the selected bitrate.

At 480, the NEF 420 may forward, to the application server 410 via configuration parameter signaling, the indication to fetch the selected bitrate.

At 485, the application server 410 may output, to the UPF 425 via measurement reporting signaling, user data signaling, or both, source bitrate information (e.g., a minimum required bitrate to maintain the threshold QoE) and accompanying data. The UPF 425 may forward the source bitrate information and accompanying data to the RAN node 405.

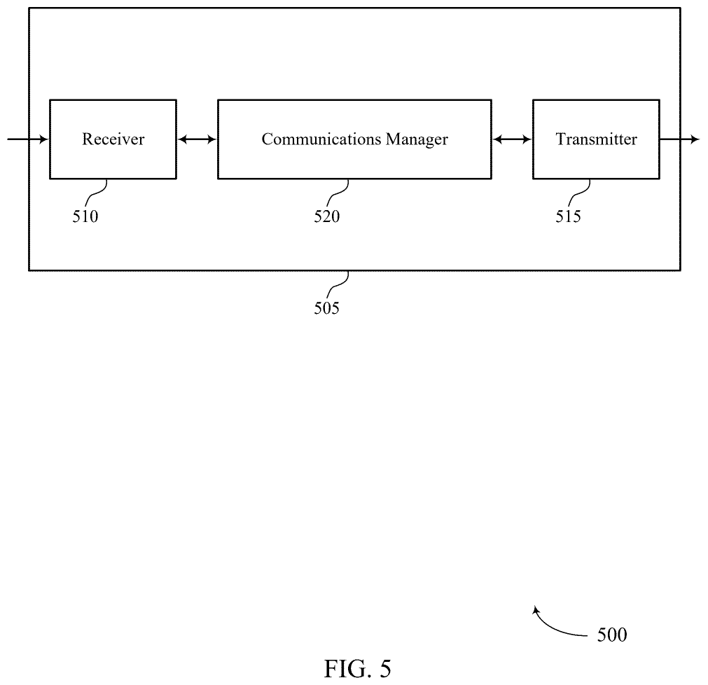

FIG. 5 shows a block diagram 500 of a device 505 that supports RAN assisted QoE-aware source bitrate selection in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of RAN assisted QoE-aware source bitrate selection as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining one or more first messages indicative of at least a first bitrate that maintains a threshold quality of experience (QoE) for operations at a UE spanning at least a threshold duration of time. The communications manager 520 is capable of, configured to, or operable to support a means for outputting, in accordance with the one or more first messages, one or more second messages indicative of a selected bitrate for the UE.

Additionally, or alternatively, the communications manager 520 may support wireless communications in accordance with examples as disclosed herein. For example, the communications manager 520 is capable of, configured to, or operable to support a means for outputting one or more first messages indicative of at least a first bitrate that maintains a threshold quality of experience (QoE) for operations at a UE spanning at least a threshold duration of time. The communications manager 520 is capable of, configured to, or operable to support a means for obtaining, in accordance with the one or more first messages, one or more second messages indicative of a selected bitrate for the UE.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and distributed processing, more efficient utilization of communication resources, more effective coordination between network devices providing advanced applications.

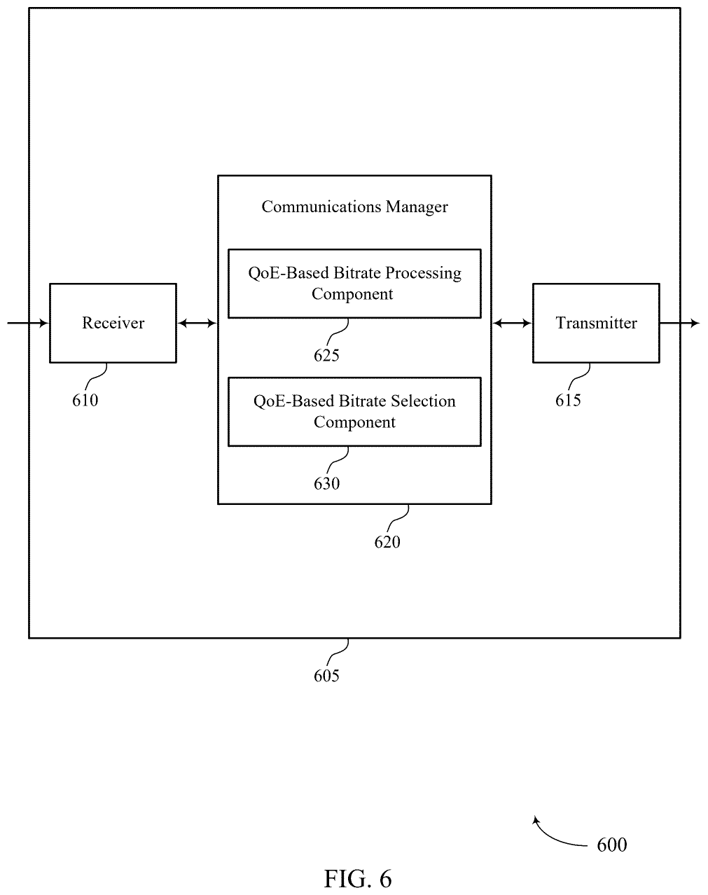

FIG. 6 shows a block diagram 600 of a device 605 that supports RAN assisted QoE-aware source bitrate selection in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of RAN assisted QoE-aware source bitrate selection as described herein. For example, the communications manager 620 may include a QoE-based bitrate processing component 625, a QoE-based bitrate processing component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The QoE-based bitrate processing component 625 is capable of, configured to, or operable to support a means for obtaining one or more first messages indicative of at least a first bitrate that maintains a threshold quality of experience (QoE) for operations at a UE spanning at least a threshold duration of time. The QoE-based bitrate processing component 630 is capable of, configured to, or operable to support a means for outputting, in accordance with the one or more first messages, one or more second messages indicative of a selected bitrate for the UE.

Additionally, or alternatively, the communications manager 620 may support wireless communications in accordance with examples as disclosed herein. The QoE-based bitrate processing component 630 is capable of, configured to, or operable to support a means for outputting one or more first messages indicative of at least a first bitrate that maintains a threshold quality of experience (QoE) for operations at a UE spanning at least a threshold duration of time. The QoE-based bitrate processing component 630 is capable of, configured to, or operable to support a means for obtaining, in accordance with the one or more first messages, one or more second messages indicative of a selected bitrate for the UE.

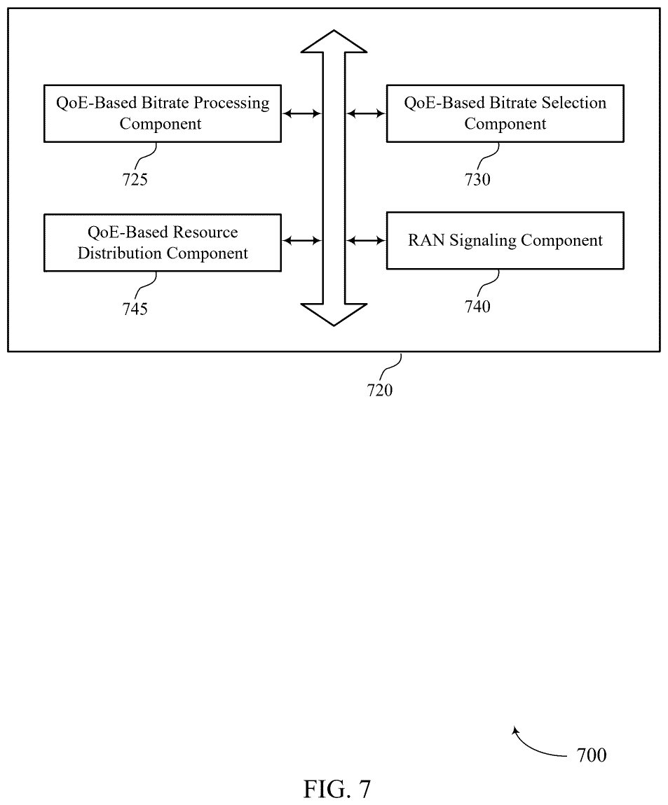

FIG. 7 shows a block diagram 700 of a communications manager 720 that supports RAN assisted QoE-aware source bitrate selection in accordance with one or more aspects of the present disclosure. The communications manager 720 may be an example of aspects of a communications manager 520, a communications manager 620, or both, as described herein. The communications manager 720, or various components thereof, may be an example of means for performing various aspects of RAN assisted QoE-aware source bitrate selection as described herein. For example, the communications manager 720 may include a QoE-based bitrate processing component 725, a QoE-based bitrate processing component 730, a RAN signaling component 740, a QoE-based resource distribution component 745, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The QoE-based bitrate processing component 725 is capable of, configured to, or operable to support a means for obtaining one or more first messages indicative of at least a first bitrate that maintains a threshold quality of experience (QoE) for operations at a UE spanning at least a threshold duration of time. The QoE-based bitrate processing component 730 is capable of, configured to, or operable to support a means for outputting, in accordance with the one or more first messages, one or more second messages indicative of a selected bitrate for the UE.

In some examples, at least the first bitrate comprises a set of bitrate values and the threshold QoE comprises a set of threshold QoE values, and the QoE-based bitrate processing component 730 is capable of, configured to, or operable to support a means for mapping, in accordance with a user experience function, the set of bitrate values to corresponding threshold QoE values of the set of threshold QoE values during the threshold duration of time.

In some examples, at least the first bitrate comprises a set of bitrate values and the threshold QoE comprises a set of threshold QoE values and the QoE-based bitrate processing component 730 is capable of, configured to, or operable to support a means for obtaining a first bitrate value of the set of bitrate values required to maintain a first threshold QoE value of the set of threshold QoE values at a first time. In some examples, at least the first bitrate comprises a set of bitrate values and the threshold QoE comprises a set of threshold QoE values, and the QoE-based bitrate processing component 730 is capable of, configured to, or operable to support a means for obtaining a second bitrate value of the set of bitrate values required to maintain a second threshold QoE value of the set of threshold QoE values at a second time different from the first time.

In some examples, the first bitrate value is different from the second bitrate value as a result of one or more application content changes at the UE and the first threshold QoE value is different from the second threshold QoE value as a result of the one or more application content changes at the UE. In some examples, the one or more application content changes include one or more changes in video content complexity, extended reality content complexity, virtual reality content complexity, mixed reality content complexity, one or more changes in streaming content, or any combination thereof.

In some examples, the one or more first messages further include PDU set metadata indicative of data traffic at the UE. In some examples, to support obtaining the one or more first messages, the RAN signaling component 740 is capable of, configured to, or operable to support a means for obtaining the one or more first messages from an application server via a session management function.

In some examples, the RAN signaling component 740 is capable of, configured to, or operable to support a means for outputting an indication of a request to update the threshold QoE based on satisfaction of one or more criteria. In some examples, satisfaction of the one or more criteria includes completion of a threshold periodicity, an occurrence of one or more events corresponding to a change in QoE, or both.

In some examples, to support obtaining the one or more first messages, the RAN signaling component 740 is capable of, configured to, or operable to support a means for obtaining the one or more first messages via one or more application servers associated with one or more respective UEs, the method further including. In some examples, to support obtaining the one or more first messages, the QoE-based resource distribution component 745 is capable of, configured to, or operable to support a means for calculating, in accordance with respective link conditions associated with the one or more respective UEs, a resource distribution for the one or more respective UEs, where the resource distribution includes a selected bitrate that satisfies (e.g., maximizes, optimizes) a QoE-based network utility function for a threshold quantity of the one or more respective UEs. In some examples, to support obtaining the one or more first messages, the QoE-based bitrate processing component 730 is capable of, configured to, or operable to support a means for outputting, to the one or more application servers, one or more QoS notification messages indicative of the selected bitrate.

In some examples, the QoE-based resource distribution component 745 is capable of, configured to, or operable to support a means for calculating an updated resource distribution for the one or more respective UEs, the updated resource distribution including updated selected bitrates associated with the one or more respective UEs. In some examples, the QoE-based bitrate processing component 730 is capable of, configured to, or operable to support a means for outputting one or more updated QoS notification messages based on the updated selected bitrates. In some examples, the one or more QoS notification messages includes an indication of whether the threshold QoE will be achieved by at least one of the one or more respective UEs.

In some examples, to support calculating the resource distribution and the selected bitrate for the one or more respective UEs, the QoE-based resource distribution component 745 is capable of, configured to, or operable to support a means for calculating the resource distribution and the selected bitrate in accordance with a bitrate selection algorithm implemented at the RAN node.

In some examples, the RAN signaling component 740 is capable of, configured to, or operable to support a means for outputting, to the UE, an indication of a requested set of UE measurements to perform. In some examples, the RAN signaling component 740 is capable of, configured to, or operable to support a means for obtaining, from the UE, a measurement reporting including the requested set of UE measurements in accordance with the indication.

In some examples, the selected bitrate satisfies the first bitrate that maintains the threshold QoE, or the selected bitrate fails to satisfy the first bitrate that maintains threshold QoE based on a capacity of the RAN node. In some examples, the threshold duration of time includes a threshold quantity of frames or a threshold quantity of time segments.

Additionally, or alternatively, the communications manager 720 may support wireless communications in accordance with examples as disclosed herein. In some examples, the QoE-based bitrate processing component 730 is capable of, configured to, or operable to support a means for outputting one or more first messages indicative of at least a first bitrate that maintains a threshold quality of experience (QoE) for operations at a UE spanning at least a threshold duration of time. The QoE-based bitrate processing component 730 is capable of, configured to, or operable to support a means for obtaining, in accordance with the one or more first messages, one or more second messages indicative of a selected bitrate for the UE. In some examples, at least the first bitrate comprises a set of bitrate values and the threshold QoE comprises a set of threshold QoE values, and the QoE-based bitrate processing component 730 is capable of, configured to, or operable to support a means for estimating, in accordance with a user experience function, the set of bitrate values to corresponding threshold QoE values of the set of threshold QoE values during the threshold duration of time.

In some examples, at least the first bitrate comprises a set of bitrate values and the threshold QoE comprises a set of threshold QoE values, and the QoE-based bitrate processing component 730 is capable of, configured to, or operable to support a means for obtaining a first bitrate value of the set of bitrate values required to maintain a first threshold QoE value of the set of threshold QoE values at a first time. In some examples, at least the first bitrate comprises a set of bitrate values and the threshold QoE comprises a set of threshold QoE values, and the QoE-based bitrate processing component 730 is capable of, configured to, or operable to support a means for obtaining a second bitrate value of the set of bitrate values required to maintain a second threshold QoE value of the set of threshold QoE values at a second time different from the first time.

In some examples, the first bitrate value is different from the second bitrate value as a result of one or more application content changes at the UE and the first threshold QoE value is different from the second threshold QoE value as a result of the one or more application content changes at the UE. In some examples, the one or more application content changes include one or more changes in video content complexity, extended reality content complexity, virtual reality content complexity, mixed reality content complexity, one or more changes in streaming content, or any combination thereof. In some examples, the one or more first messages further include PDU set metadata indicative of data traffic at the UE.

In some examples, the RAN signaling component 740 is capable of, configured to, or operable to support a means for obtaining, from a radio access network (RAN) node, an indication of a request to update the threshold QoE based on satisfaction of one or more criteria. In some examples, the satisfaction of the one or more criteria include completion of a threshold periodicity, an occurrence of one or more events corresponding to a change in QoE, or both.

In some examples, the QoE-based bitrate processing component 730 is capable of, configured to, or operable to support a means for obtaining one or more QoS notification messages indicative of a bitrate required to maintain the threshold QoE for operations at the UE and one or more other UEs.

In some examples, the QoE-based bitrate processing component 730 is capable of, configured to, or operable to support a means for obtaining one or more updated QoS notification messages including updated selected bitrates based on one or more changes to resource distribution for the UE and the one or more other UEs. In some examples, the QoE-based bitrate processing component 730 is capable of, configured to, or operable to support a means for modifying an encoding bitrate at the application function in accordance with the selected bitrate. In some examples, the one or more QoS notification messages includes an indication of whether the threshold QoE will be achieved by the UE. In some examples, the threshold duration of time includes a threshold quantity of frames or a threshold quantity of time segments.

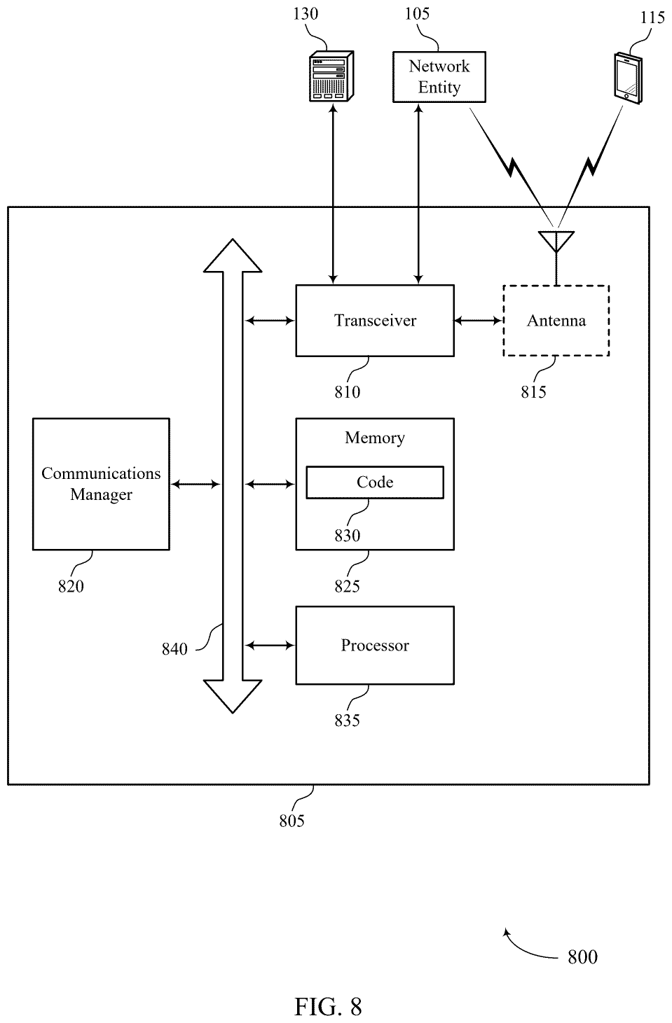

FIG. 8 shows a diagram of a system 800 including a device 805 that supports RAN assisted QoE-aware source bitrate selection in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting RAN assisted QoE-aware source bitrate selection). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining one or more first messages indicative of at least a first bitrate that maintains a threshold quality of experience (QoE) for operations at a UE spanning at least a threshold duration of time. The communications manager 820 is capable of, configured to, or operable to support a means for outputting, in accordance with the one or more first messages, one or more second messages indicative of a selected bitrate for the UE.

Additionally, or alternatively, the communications manager 820 may support wireless communications in accordance with examples as disclosed herein. For example, the communications manager 820 is capable of, configured to, or operable to support a means for outputting one or more first messages indicative of at least a first bitrate that maintains a threshold quality of experience (QoE) for operations at a UE spanning at least a threshold duration of time. The communications manager 820 is capable of, configured to, or operable to support a means for obtaining, in accordance with the one or more first messages, one or more second messages indicative of a selected bitrate for the UE.

By including or configuring the communications manager 820 in accordance with examples as described herein, the device 805 may support techniques for improved communication reliability, reduced latency, improved user experience related to reduced processing and more flexibly adapted bitrates, more efficient utilization of communication resources, improved coordination between devices, distributed processing across network devices, and improved overall video quality and user experience across users in multi-user systems.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of RAN assisted QoE-aware source bitrate selection as described herein, or the at least one processor 835 and the at least one memory 825 may be otherwise configured to, individually or collectively, perform or support such operations.

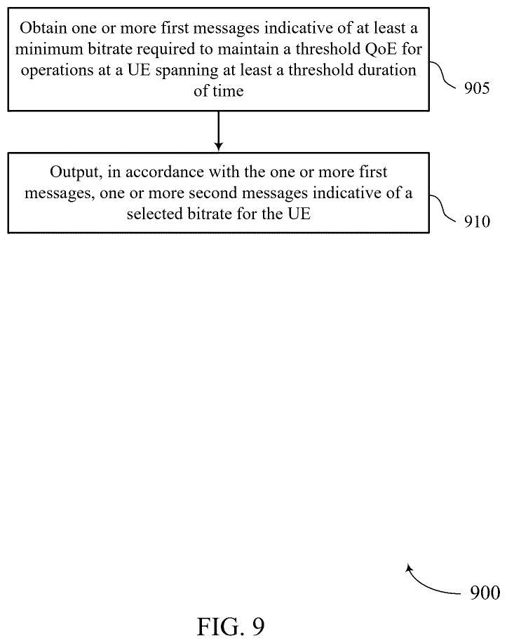

FIG. 9 shows a flowchart illustrating a method 900 that supports RAN assisted QoE-aware source bitrate selection in accordance with one or more aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining one or more first messages indicative of at least a first bitrate that maintains a threshold quality of experience (QoE) for operations at a UE spanning at least a threshold duration of time. The operations of 905 may be performed in accordance with examples as disclosed herein. In some examples, aspects of the operations of 905 may be performed by a QoE-based bitrate processing component 725 as described with reference to FIG. 7.

At 910, the method may include outputting, in accordance with the one or more first messages, one or more second messages indicative of a selected bitrate for the UE. The operations of 910 may be performed in accordance with examples as disclosed herein. In some examples, aspects of the operations of 910 may be performed by a QoE-based bitrate processing component 730 as described with reference to FIG. 7.

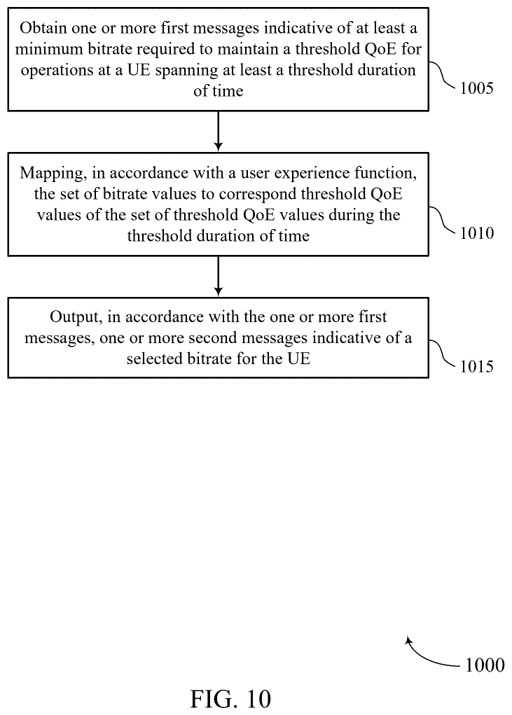

FIG. 10 shows a flowchart illustrating a method 1000 that supports RAN assisted QoE-aware source bitrate selection in accordance with one or more aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining one or more first messages indicative of at least a first bitrate that maintains a threshold quality of experience (QoE) for operations at a UE spanning at least a threshold duration of time. The operations of 1005 may be performed in accordance with examples as disclosed herein. In some examples, aspects of the operations of 1005 may be performed by a QoE-based bitrate processing component 725 as described with reference to FIG. 7.

At 1010, the method may include mapping, in accordance with a user experience function, the set of bitrate values to corresponding threshold QoE values of the set of threshold QoE values during the threshold duration of time. The operations of 1010 may be performed in accordance with examples as disclosed herein. In some examples, aspects of the operations of 1010 may be performed by a QoE-based bitrate processing component 730 as described with reference to FIG. 7.

At 1015, the method may include outputting, in accordance with the one or more first messages, one or more second messages indicative of a selected bitrate for the UE. The operations of 1015 may be performed in accordance with examples as disclosed herein. In some examples, aspects of the operations of 1015 may be performed by a QoE-based bitrate processing component 730 as described with reference to FIG. 7.

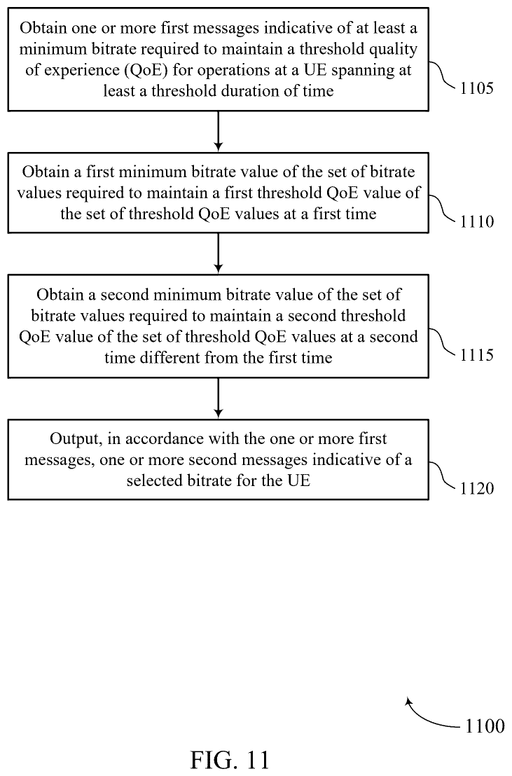

FIG. 11 shows a flowchart illustrating a method 1100 that supports RAN assisted QoE-aware source bitrate selection in accordance with one or more aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include obtaining one or more first messages indicative of at least a first bitrate that maintains a threshold quality of experience (QoE) for operations at a UE spanning at least a threshold duration of time. The operations of 1105 may be performed in accordance with examples as disclosed herein. In some examples, aspects of the operations of 1105 may be performed by a QoE-based bitrate processing component 725 as described with reference to FIG. 7.

At 1110, the method may include obtaining a first bitrate value of the set of bitrate values required to maintain a first threshold QoE value of the set of threshold QoE values at a first time. The operations of 1110 may be performed in accordance with examples as disclosed herein. In some examples, aspects of the operations of 1110 may be performed by a QoE-based bitrate processing component 730 as described with reference to FIG. 7.

At 1115, the method may include obtaining a second bitrate value of the set of bitrate values required to maintain a second threshold QoE value of the set of threshold QoE values at a second time different from the first time. The operations of 1115 may be performed in accordance with examples as disclosed herein. In some examples, aspects of the operations of 1115 may be performed by a QoE-based bitrate processing component 730 as described with reference to FIG. 7.

At 1120, the method may include outputting, in accordance with the one or more first messages, one or more second messages indicative of a selected bitrate for the UE. The operations of 1120 may be performed in accordance with examples as disclosed herein. In some examples, aspects of the operations of 1120 may be performed by a QoE-based bitrate processing component 730 as described with reference to FIG. 7.

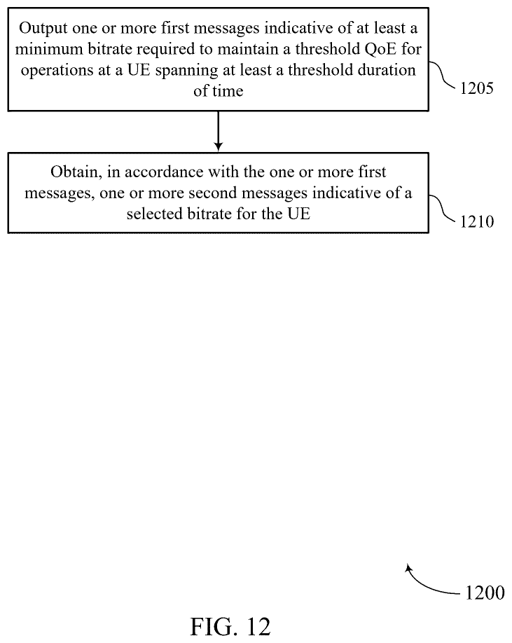

FIG. 12 shows a flowchart illustrating a method 1200 that supports RAN assisted QoE-aware source bitrate selection in accordance with one or more aspects of the present disclosure. The operations of the method 1200 may be implemented by a network entity or its components as described herein. For example, the operations of the method 1200 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1205, the method may include outputting one or more first messages indicative of at least a first bitrate that maintains a threshold quality of experience (QoE) for operations at a UE spanning at least a threshold duration of time. The operations of 1205 may be performed in accordance with examples as disclosed herein. In some examples, aspects of the operations of 1205 may be performed by a QoE-based bitrate processing component 730 as described with reference to FIG. 7.

At 1210, the method may include obtaining, in accordance with the one or more first messages, one or more second messages indicative of a selected bitrate for the UE. The operations of 1210 may be performed in accordance with examples as disclosed herein. In some examples, aspects of the operations of 1210 may be performed by a QoE-based bitrate processing component 730 as described with reference to FIG. 7.

The following provides an overview of aspects of the present disclosure:
Aspect 1: A method for wireless communications at a radio access network (RAN) node, comprising: obtaining one or more first messages indicative of at least a first bitrate that maintains a threshold QoE for operations at a UE spanning at least a threshold duration of time; and outputting, in accordance with the one or more first messages, one or more second messages indicative of a selected bitrate for the UE.
Aspect 2: The method of aspect 1, wherein at least the first bitrate comprises a set of bitrate values and the threshold QoE comprises a set of threshold QoE values, the method further comprising: mapping, in accordance with a user experience function, the set of bitrate values to corresponding threshold QoE values of the set of threshold QoE values during the threshold duration of time.
Aspect 3: The method of any of aspects 1 through 2, wherein at least the first bitrate comprises a set of bitrate values and the threshold QoE comprises a set of threshold QoE values, the method further comprising: obtaining a first bitrate value of the set of bitrate values required to maintain a first threshold QoE value of the set of threshold QoE values at a first time; and obtaining a second bitrate value of the set of bitrate values required to maintain a second threshold QoE value of the set of threshold QoE values at a second time different from the first time.
Aspect 4: The method of aspect 3, wherein the first bitrate value is different from the second bitrate value as a result of one or more application content changes at the UE and the first threshold QoE value is different from the second threshold QoE value as a result of the one or more application content changes at the UE.
Aspect 5: The method of aspect 4, wherein the one or more application content changes comprise one or more changes in video content complexity, extended reality content complexity, virtual reality content complexity, mixed reality content complexity, one or more changes in streaming content, or any combination thereof.
Aspect 6: The method of any of aspects 1 through 5, wherein the one or more first messages further comprise PDU set metadata indicative of data traffic at the UE.
Aspect 7: The method of any of aspects 1 through 6, wherein obtaining the one or more first messages comprises: obtaining the one or more first messages from an application server via a session management function.
Aspect 8: The method of any of aspects 1 through 7, further comprising: outputting an indication of a request to update the threshold QoE based at least in part on satisfaction of one or more criteria.
Aspect 9: The method of aspect 8, wherein satisfaction of the one or more criteria comprises completion of a threshold periodicity, an occurrence of one or more events corresponding to a change in QoE, or both.
Aspect 10: The method of any of aspects 1 through 9, wherein obtaining the one or more first messages comprises: obtaining the one or more first messages via one or more application servers associated with one or more respective UEs, the method further comprising: calculating, in accordance with respective link conditions associated with the one or more respective UEs, a resource distribution for the one or more respective UEs, wherein the resource distribution comprises a selected bitrate that satisfies a QoE-based network utility function for a threshold quantity of the one or more respective UEs; and outputting, to the one or more application servers, one or more QoS notification messages indicative of the selected bitrate.
Aspect 11: The method of aspect 10, further comprising: calculating an updated resource distribution for the one or more respective UEs, the updated resource distribution comprising updated selected bitrates associated with the one or more respective UEs; and outputting one or more updated QoS notification messages based at least in part on the updated selected bitrates.
Aspect 12: The method of any of aspects 10 through 11, wherein the one or more QoS notification messages comprises an indication of whether the threshold QoE will be achieved by at least one of the one or more respective UEs.
Aspect 13: The method of any of aspects 10 through 12, wherein calculating the resource distribution and the selected bitrate for the one or more respective UEs comprises: calculating the resource distribution and the selected bitrate in accordance with a bitrate selection algorithm implemented at the RAN node.
Aspect 14: The method of any of aspects 1 through 13, further comprising: outputting, to the UE, an indication of a requested set of UE measurements to perform; and obtaining, from the UE, a measurement reporting comprising the requested set of UE measurements in accordance with the indication.
Aspect 15: The method of any of aspects 1 through 14, wherein the selected bitrate satisfies the first bitrate that maintains the threshold QoE, or the selected bitrate fails to satisfy the first bitrate that maintains threshold QoE based at least in part on a capacity of the RAN node.
Aspect 16: The method of any of aspects 1 through 15, wherein the threshold duration of time comprises a threshold quantity of frames or a threshold quantity of time segments.
Aspect 17: A method for wireless communications at an application function, comprising: outputting one or more first messages indicative of at least a first bitrate that maintains a threshold QoE for operations at a UE spanning at least a threshold duration of time; and obtaining, in accordance with the one or more first messages, one or more second messages indicative of a selected bitrate for the UE.
Aspect 18: The method of aspect 17, wherein at least the first bitrate comprises a set of bitrate values and the threshold QoE comprises a set of threshold QoE values, the method further comprising: estimating, in accordance with a user experience function, the set of bitrate values to corresponding threshold QoE values of the set of threshold QoE values during the threshold duration of time.
Aspect 19: The method of any of aspects 17 through 18, wherein at least the first bitrate comprises a set of bitrate values and the threshold QoE comprises a set of threshold QoE values, the method further comprising: obtaining a first bitrate value of the set of bitrate values required to maintain a first threshold QoE value of the set of threshold QoE values at a first time; and obtaining a second bitrate value of the set of bitrate values required to maintain a second threshold QoE value of the set of threshold QoE values at a second time different from the first time.
Aspect 20: The method of aspect 19, wherein the first bitrate value is different from the second bitrate value as a result of one or more application content changes at the UE and the first threshold QoE value is different from the second threshold QoE value as a result of the one or more application content changes associated at the UE.
Aspect 21: The method of aspect 20, wherein the one or more application content changes comprise one or more changes in video content complexity, extended reality content complexity, virtual reality content complexity, mixed reality content complexity, one or more changes in streaming content, or any combination thereof.
Aspect 22: The method of any of aspects 17 through 21, wherein the one or more first messages further comprise PDU set metadata indicative of data traffic at the UE.
Aspect 23: The method of any of aspects 17 through 22, further comprising: obtaining, from a RAN node, an indication of a request to update the threshold QoE based at least in part on satisfaction of one or more criteria.
Aspect 24: The method of aspect 23, wherein the satisfaction of the one or more criteria comprise completion of a threshold periodicity, an occurrence of one or more events corresponding to a change in QoE, or both.
Aspect 25: The method of any of aspects 17 through 24, further comprising: obtaining one or more QoS notification messages indicative of a bitrate required to maintain the threshold QoE for operations at the UE and one or more other UEs.
Aspect 26: The method of aspect 25, further comprising: obtaining one or more updated QoS notification messages comprising updated selected bitrates based at least in part on one or more changes to resource distribution for the UE and the one or more other UEs.
Aspect 27: The method of any of aspects 25 through 26, further comprising: modifying an encoding bitrate at the application function in accordance with the selected bitrate.
Aspect 28: The method of any of aspects 25 through 27, wherein the one or more QoS notification messages comprises an indication of whether the threshold QoE will be achieved by the UE.
Aspect 29: The method of any of aspects 17 through 28, wherein the threshold duration of time comprises a threshold quantity of frames or a threshold quantity of time segments.
Aspect 30: A RAN node for wireless communications, comprising one or more memories storing processor-executable code, and one or more processors coupled with the one or more memories and individually or collectively operable to execute the code to cause the RAN node to perform a method of any of aspects 1 through 16.
Aspect 31: A RAN node for wireless communications, comprising at least one means for performing a method of any of aspects 1 through 16.
Aspect 32: A non-transitory computer-readable medium storing code for wireless communications, the code comprising instructions executable by one or more processors to perform a method of any of aspects 1 through 16.
Aspect 33: An application function for wireless communications, comprising one or more memories storing processor-executable code, and one or more processors coupled with the one or more memories and individually or collectively operable to execute the code to cause the application function to perform a method of any of aspects 17 through 29.
Aspect 34: An application function for wireless communications, comprising at least one means for performing a method of any of aspects 17 through 29.
Aspect 35: A non-transitory computer-readable medium storing code for wireless communications, the code comprising instructions executable by one or more processors to perform a method of any of aspects 17 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A radio access network (RAN) node, comprising:
one or more memories storing processor-executable code; and
one or more processors coupled with the one or more memories and individually or collectively operable to execute the code to cause the radio access network (RAN) node to:
obtain one or more first messages indicative of at least a first bitrate that maintains a threshold quality of experience (QoE) for operations at a user equipment (UE) spanning at least a threshold duration of time; and
output, in accordance with the one or more first messages, one or more second messages indicative of a selected bitrate for the UE.

2. The RAN node of claim 1, wherein at least the first bitrate comprises a set of bitrate values and the threshold QoE comprises a set of threshold QoE values, and the one or more processors are individually or collectively further operable to execute the code to cause the RAN node to:
map, in accordance with a user experience function, the set of bitrate values to corresponding threshold QoE values of the set of threshold QoE values during the threshold duration of time.

3. The RAN node of claim 1, wherein at least the first bitrate comprises a set of bitrate values and the threshold QoE comprises a set of threshold QoE values, and the one or more processors are individually or collectively further operable to execute the code to cause the RAN node to:
obtain a first bitrate value of the set of bitrate values that maintains a first threshold QoE value of the set of threshold QoE values at a first time; and
obtain a second bitrate value of the set of bitrate values that maintains a second threshold QoE value of the set of threshold QoE values at a second time different from the first time.

4. The RAN node of claim 3, wherein:
the first bitrate value is different from the second bitrate value as a result of one or more application content changes at the UE; and
the first threshold QoE value is different from the second threshold QoE value as a result of the one or more application content changes at the UE.

5. The RAN node of claim 4, wherein the one or more application content changes comprise one or more changes in video content complexity, extended reality content complexity, virtual reality content complexity, mixed reality content complexity, one or more changes in streaming content, or any combination thereof.

6. The RAN node of claim 1, wherein the one or more first messages further comprise packet data unit (PDU) set metadata indicative of data traffic at the UE.

7. The RAN node of claim 1, wherein, to obtain the one or more first messages, the one or more processors are individually or collectively operable to execute the code to cause the RAN node to:
obtain the one or more first messages from an application server via a session management function.

8. The RAN node of claim 1, wherein the one or more processors are individually or collectively further operable to execute the code to cause the RAN node to:
output an indication of a request to update the threshold QoE based at least in part on satisfaction of one or more criteria.

9. The RAN node of claim 8, wherein satisfaction of the one or more criteria comprises completion of a threshold periodicity, an occurrence of one or more events corresponding to a change in QoE, or both.

10. The RAN node of claim 1, wherein, to obtain the one or more first messages, the one or more processors are individually or collectively operable to execute the code to cause the RAN node to:
obtain the one or more first messages via one or more application servers associated with one or more respective UEs, wherein the one or more processors are individually or collectively further operable to execute the code to cause the RAN node to:
calculate, in accordance with respective link conditions associated with the one or more respective UEs, a resource distribution for the one or more respective UEs, wherein the resource distribution comprises a selected bitrate that satisfies a QoE-based network utility function for a threshold quantity of the one or more respective UEs; and
output, to the one or more application servers, one or more QoS notification messages indicative of the selected bitrate.

11. The RAN node of claim 10, wherein the one or more processors are individually or collectively further operable to execute the code to cause the RAN node to:
calculate an updated resource distribution for the one or more respective UEs, the updated resource distribution comprising updated selected bitrates associated with the one or more respective UEs; and
output one or more updated QoS notification messages based at least in part on the updated selected bitrates.

12. The RAN node of claim 10, wherein the one or more QoS notification messages comprises an indication of whether the threshold QoE will be achieved by at least one of the one or more respective UEs.

13. The RAN node of claim 10, wherein, to calculate the resource distribution and the selected bitrate for the one or more respective UEs, the one or more processors are individually or collectively operable to execute the code to cause the RAN node to:
calculate the resource distribution and the selected bitrate in accordance with a bitrate selection algorithm implemented at the RAN node.

14. The RAN node of claim 1, wherein the one or more processors are individually or collectively further operable to execute the code to cause the RAN node to:
output, to the UE, an indication of a requested set of UE measurements to perform; and
obtain, from the UE, a measurement reporting comprising the requested set of UE measurements in accordance with the indication.

15. The RAN node of claim 1, wherein:
the selected bitrate satisfies the first bitrate that maintains the threshold QoE; or
the selected bitrate fails to satisfy the first bitrate that maintains threshold QoE based at least in part on a capacity of the RAN node.

16. The RAN node of claim 1, wherein the threshold duration of time comprises a threshold quantity of frames or a threshold quantity of time segments.

17. An application function, comprising:
one or more memories storing processor-executable code; and
one or more processors coupled with the one or more memories and individually or collectively operable to execute the code to cause the application function to:
output one or more first messages indicative of at least a first bitrate that maintains a threshold quality of experience (QoE) for operations at a user equipment (UE) spanning at least a threshold duration of time; and
obtain, in accordance with the one or more first messages, one or more second messages indicative of a selected bitrate for the UE.

18. The application function of claim 17, wherein at least the first bitrate comprises a set of bitrate values and the threshold QoE comprises a set of threshold QoE values, and the one or more processors are individually or collectively further operable to execute the code to cause the application function to:
estimate, in accordance with a user experience function, the set of bitrate values to corresponding threshold QoE values of the set of threshold QoE values during the threshold duration of time.

19. The application function of claim 17, wherein at least the first bitrate comprises a set of bitrate values and the threshold QoE comprises a set of threshold QoE values, and the one or more processors are individually or collectively further operable to execute the code to cause the application function to:
obtain a first bitrate value of the set of bitrate values that maintains a first threshold QoE value of the set of threshold QoE values at a first time; and
obtain a second bitrate value of the set of bitrate values that maintains a second threshold QoE value of the set of threshold QoE values at a second time different from the first time.

20. The application function of claim 19, wherein:
the first bitrate value is different from the second bitrate value as a result of one or more application content changes at the UE; and
the first threshold QoE value is different from the second threshold QoE value as a result of the one or more application content changes at the UE.

21. The application function of claim 20, wherein the one or more application content changes comprise one or more changes in video content complexity, extended reality content complexity, virtual reality content complexity, mixed reality content complexity, one or more changes in streaming content, or any combination thereof.

22. The application function of claim 17, wherein the one or more first messages further comprise packet data unit (PDU) set metadata indicative of data traffic at the UE.

23. The application function of claim 17, wherein the one or more processors are individually or collectively further operable to execute the code to cause the application function to:
obtain, from a radio access network (RAN) node, an indication of a request to update the threshold QoE based at least in part on satisfaction of one or more criteria.

24. The application function of claim 23, wherein the satisfaction of the one or more criteria comprise completion of a threshold periodicity, an occurrence of one or more events corresponding to a change in QoE, or both.

25. The application function of claim 17, wherein the one or more processors are individually or collectively further operable to execute the code to cause the application function to:
obtain one or more QoS notification messages indicative of a bitrate that maintains the threshold QoE for operations at the UE and one or more other UEs.

26. The application function of claim 25, wherein the one or more processors are individually or collectively further operable to execute the code to cause the application function to:
obtain one or more updated QoS notification messages comprising updated selected bitrates based at least in part on one or more changes to a resource distribution for the UE and the one or more other UEs.

27. The application function of claim 25, wherein the one or more processors are individually or collectively further operable to execute the code to cause the application function to:
modify an encoding bitrate at the application function in accordance with the selected bitrate.

28. The application function of claim 25, wherein the one or more QoS notification messages comprises an indication of whether the threshold QoE will be achieved by the UE.

29. A method for wireless communications at a radio access network (RAN) node, comprising:
obtaining one or more first messages indicative of at least a first bitrate that maintains a threshold quality of experience (QoE) for operations at a user equipment (UE) spanning at least a threshold duration of time; and
outputting, in accordance with the one or more first messages, one or more second messages indicative of a selected bitrate for the UE.

30. A method for wireless communications at an application function, comprising:
outputting one or more first messages indicative of at least a first bitrate that maintains a threshold quality of experience (QoE) for operations at a user equipment (UE) spanning at least a threshold duration of time; and
obtaining, in accordance with the one or more first messages, one or more second messages indicative of a selected bitrate for the UE.
